(19) United States
(12) Patent Application Publication
(10) Pub. No.: US 2005/0158620 A1
(43) Pub. Date: Jul. 21, 2005

(54) Secondary battery

(76) Inventors: Yong-Sam Kim, Suwon-si (KR); Ki-Ho Kim, Suwon-si (KR); Jae-Yul Ryu, Suwon-si (KR); Seok-Yoon Yoo, Suwon-si (KR)

Correspondence Address: CHRISTIE, PARKER & HALE, LLP, PO BOX 7068, PASADENA, CA, 91109-7068, US

(21) Appl. No.: 11/031,551

(22) Filed: Jan. 5, 2005

(30) Foreign Application Priority Data
Jan. 16, 2004 (KR) 10-2004-0003261

(51) Int. Cl. H01M 2/26; H01M 2/08

(52) U.S. Cl. 429/161; 429/185; 429/174

(57) ABSTRACT

A secondary battery includes a container; an electrode assembly having a positive plate, a negative plate, and a separator interposed between those two plates. The electrode assembly is mounted inside the container and a cap assembly is fixed to the container to seal the container. A positive collector plate and a negative collector plate are electrically connected to the positive and negative plates of the electrode assembly. At least one collector plate of the positive and negative collector plates includes a plate-shaped body and a contact portion projecting from the body to contact the collector of the corresponding plate.

### CROSS-REFERENCE TO RELATED APPLICATION

This application claims the benefit of and priority to Korean Patent Application No. 10-2004-0003261 filed on Jan. 16, 2004 in the Korean Intellectual Property Office, the entire disclosure of which is incorporated herein by reference.

### FIELD OF THE INVENTION

The present invention relates to a secondary battery, and more particularly, to a structure connecting an external battery terminal of a cap assembly and an electrode assembly mounted inside a battery container.

### BACKGROUND OF THE INVENTION

Non-aqueous electrolyte secondary batteries are used as high power secondary batteries for environmental friendly motor drives and for slim and portable electronic devices. The positive plate and the negative plate of a non-aqueous electrolyte secondary battery generally comprises an alkaline metal such as lithium, and the container for the secondary battery has a sealed structure so as prevent the alkaline metal from reacting with moisture from the air.

Such a secondary battery with a sealed structure includes a container having an opening at its upper end, an electrode assembly mounted inside the container and immersed in an electrolyte, and an external terminal fixed to the container to seal the battery, for example, by a cap assembly with a positive terminal. A positive plate of the electrode assembly has a structure connected to the cap assembly through a tab.

The secondary battery with the above-mentioned structure is problematic in that the tab connecting the electrode assembly to the external terminal cannot easily carry the voltage generated from each region of the electrode assembly, and can cause voltage differences between a region where the electrode assembly is welded to the tab and other regions distant the tab. Such a voltage difference increases the deterioration of the welded portion as the charge and discharge is repeated, and also results in reduced power and life span for the battery. Such problems are especially serious for a battery for a motor drive which repeats the charge and discharge within a short time.

Japanese Patent Laid Open No. 2003-7346 describes a secondary battery in an effort to overcome the above difficulties. The secondary battery has plural tabs along one direction of the electrode assembly, and the tabs are fixed to an internal terminal which is connected to an external terminal.

The tabs of the secondary battery mentioned above are integrally formed with the collector, or separately manufactured and then welded to the collector. Where the tabs are integrally formed with the collector, a large amount of raw materials are required for the collector, and where the tabs are separately manufactured and then welded to the collector, several manufacturing steps are required. In particular, where plural tabs are welded to an internal terminal, in order to minimize the influence to the electrode assembly by the heat generated from the tabs, the length of the tabs are relatively increased. The increase of the length of the tabs needs more space for tabs and thereby decreases the energy density per unit volume of the secondary battery.

Japanese Patent Laid Open 2001-102029 and U.S. Pat. Nos. 6,193,765 and 6,372,380 describe other examples of secondary batteries having plural tabs.

### SUMMARY OF THE INVENTION

A secondary battery is provided which can reduce the number of manufacturing steps in welding collectors and tabs, and can enhance the energy density per unit volume by reducing the space required by tabs within a battery container.

In addition, a secondary battery is provided which can enhance the collection efficiency of an electrode assembly, and can also prevent the reduction of power and reduced life span by minimizing the heat generation due to the electric potential difference.

Furthermore, the present invention provides a secondary battery which instantaneously releases power more easily so that it can be used for secondary batteries for high load motor driven devices such as electric vehicles or hybrid electric vehicles.

According to one aspect of the present invention, a secondary battery comprises a container; an electrode assembly including a positive plate, a negative plate, and a separator interposed between those two plates; and a cap assembly. The electrode assembly is mounted inside the container and the cap assembly is fixed to the container to seal the container. The positive collector plate and the negative collector plate are electrically connected to collectors of the positive and negative plates of the electrode assembly. At least one collector plate of the positive and negative collector plates includes a plate-shaped body and a contact portion projecting from the body to contact the collector of the corresponding plate.

The contact portion can have at least one groove formed with a predetermined pattern on the body.

The groove can be arranged in a radial shape on the collector plate.

The collector plate can have at least one through hole for pouring an electrolyte.

The body can have an integrally formed tab, the tab being electrically connected to the cap assembly.

The contact portion can be fixed to the collector by laser welding.

The tab can be formed as an integral part of the body by cutting a portion of the body and bending the cut portion from the body.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a secondary battery according to a first embodiment of the present invention;

FIG. 2 is a cross-sectional view of a secondary battery according to a second embodiment of the present invention;

FIG. 3 is a perspective view of a positive collector plate according to the first embodiment of the present invention;

FIG. 4 is a partial cross-sectional view illustrating the structure of a positive collector plate welded to a positive plate of an electrode assembly according to the first embodiment of the present invention; and

FIG. 5 is a perspective view of a positive collector plate according to the second embodiment of the present invention.

### DETAILED DESCRIPTION

Reference will now be made in detail to the embodiments of the present invention, examples of which are illustrated in the accompanying drawings. The embodiments are described below to explain the present invention by referring to the figures.

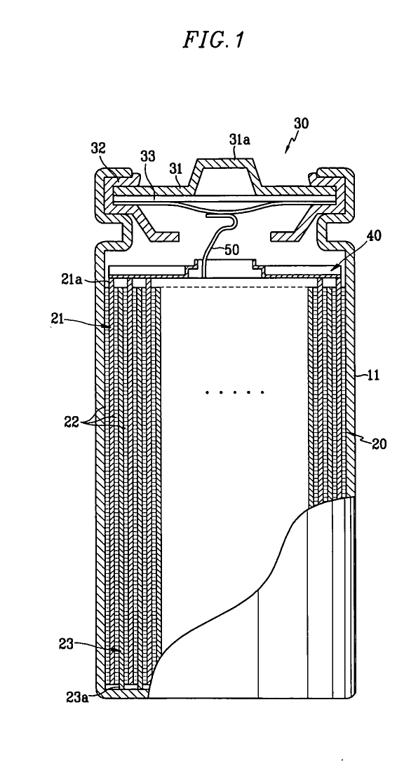

FIG. 1 is a cross-sectional view of a secondary battery according to the first embodiment of the present invention. As shown in FIG. 1, the secondary battery comprises a container 11 of a cylindrical or a hexagonal shape with an opening at the upper end thereof, an electrode assembly 20 mounted inside the container 11, a cap assembly 30 fixed to the container 11 to seal the container 11, a collector plate 40 electrically connected to a collector of a positive plate 21 of the electrode assembly 20, and a tab 50 for electrically connecting the collector plate 40 and the cap assembly 30.

The details of each element of the secondary battery will be described in the following.

The container 11 is made of conductive metal such as aluminum or aluminum alloy. While its shape is shown as a cylindrical or hexagonal shape, any shape that defines a space in which the electrode assembly 20 can be mounted as mentioned above can be used.

The electrode assembly 20 is of a stacked or layered structure such that the separator 22 is disposed between the positive plate 21 and the negative plate 23 which are coated with the corresponding active material, and stacked or rolled into a jellyroll structure. The exemplary embodiment of the present invention shows a battery with the structure that the container 11 has a cylindrical shape and the electrode assembly 20 has a jellyroll configuration.

At the lower end (for FIG. 1) of the negative plate 23 of the electrode assembly 20, an uncoated region 23a of the collector of the negative plate 23 is provided which is not coated with the negative active material. The uncoated region contacts the bottom surface of the container 11. Similarly, at the upper end (for FIG. 1) of the positive plate 21, an uncoated region 21a at the edge of the collector of the positive plate 21 is provided that is not coated with the positive active material. The uncoated region is arranged to electrically connect to the collector plate 40.

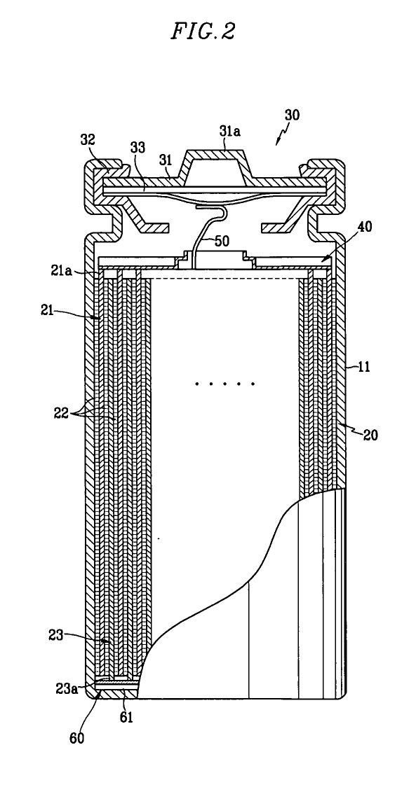

For the embodiment of FIG. 2, an optional negative collector plate 60 is arranged between the negative plate 23 and the container 11 to contact the uncoated region 23a of the negative plate 23 and the bottom surface of the container 11.

The cap assembly 30 is fixed to the container 11 to seal the container 11, and includes a cap plate 31 having an external terminal 31a, and a gasket 32 for insulating the cap plate 31 from the container 11. The cap assembly 30 and container 11 together define a space to buffer the internal pressure, and can further include a vent plate 33 with a safety valve (not shown) which opens at a prescribed pressure to discharge gas in a high pressure situation, thereby preventing the explosion of the battery. The safety valve further causes an electrical short-circuit between the external terminal and the electrode assembly 20 through the tab 50 at the prescribed pressure level.

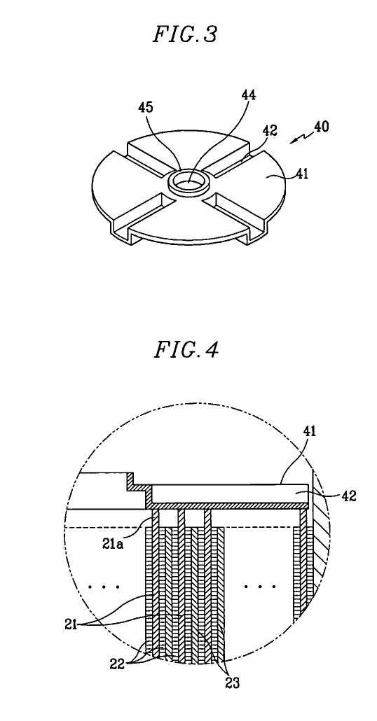

As shown in FIG. 3, the collector plate 40 has a body 41 of a disk shape, and the body 41 has at least one groove 42 which projects toward the electrode assembly 20 and functions as a contact portion for electrically contacting with the uncoated region 21 a of the positive plate 21.

The shape of the body 41 is not limited to the disk shape, and it can be a triangle, a square or a polygonal shape. The groove 42 is preferably formed as an integral part of the body 41 such as by a beading process. In one embodiment, a plurality of grooves 42 are provided, arranged radially. For example, as shown in the drawings, four grooves are arranged in a cross shape on the body 41.

Although the groove 42 of the exemplary embodiment of the present invention is formed in a straight line shape from the edge of the body 41 toward the center of the body 41, it can also be formed in an embossed shape where the embossments are spaced at a predetermined distance. In addition, while for this embodiment, the cross section of the groove is of a rectangular shape, its cross section may be of various shapes such as a square, a triangle, or a semicircle.

The body 41 further includes a center hole 44 at its center portion with a gripping portion 45 projecting from the edge of the center hole.

As shown in FIG. 4, when a secondary battery with the structure mentioned above is manufactured, the collector plate 40 is placed on the upper surface of the electrode assembly 20 which is mounted inside the container 11, and the collector plate 40 is connected to the positive plate 21 of the electrode assembly 20. The connection is achieved by laser welding the grooves 42 of the collector plate 40 to the uncoated region 21a of the positive plate 21.

The secondary battery 10 with the structure of the collector plate 40 mentioned above provides a more stable contact between the collector plate 40 and the electrode assembly 20 through the use of the groove 42. The more stable contact permits it to collect the current from the electrode assembly 20 more efficiently. Furthermore, by welding the collector plate 40 to the electrode assembly 20, manufacturing efficiency improves.

An optional negative collector plate 60 as shown in FIG. 2 can also achieve the same effects as those for the collector plate 40 described above. The structure of the contact portion 61 of the negative collector plate 60 and the fixing of the negative plate 23 to the electrode assembly 20 can be achieved by the same methods and structures as described above for the positive collector plate 40.

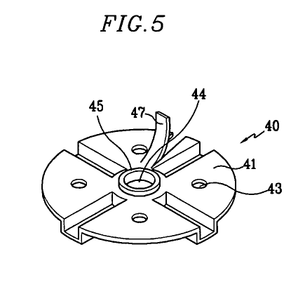

According to another embodiment of the present invention, the positive collector plate 40 includes further optional features as illustrated in FIG. 5, a perspective view of a positive collector plate 40 according to another embodiment of the present invention. As shown, the basic structure is the same as for the collector plate mentioned above.

The collector plate 40 has a body 41 of a disk shape, and the body 41 has a plurality of grooves 42 for electrically contacting the electrode assembly. The collector plate 40 has at least one through hole 43 on the body 41 for more easily pouring electrolyte into the container 11 from outside of the collector plate 40.

Furthermore, the collector plate 40 has a tab 47 for electrically connecting the collector plate 40 to the cap assembly, the tab being formed as an integral part of the body. The tab is formed by cutting a portion of the body 41 and bending the resulting tab away from the body 41 while remaining integral to the body 41.

According to this structure, the collector plate 40 is connected to the cap assembly 30 through the integral tab 47. The use of an integral tab 47 helps to prevent the tab 47 from breaking from the collector plate 40 and the cap assembly 47, and thereby improves the function of the secondary battery.

The secondary battery of the present invention can be used as the power source for high load motor driven devices such as hybrid electric vehicles, electric vehicles, wireless vacuum cleaners, motorbikes, or motor scooters.

As described above, the secondary battery of the present invention can improve the electrical contact with the collector by use of a single collector plate, and can also improve the manufacturing efficiency since it is easier to weld the collector plate to the electrode assembly.

Furthermore, the secondary battery can prevent the heat generation and the deterioration of the welds by repetitive charge and discharge within a short time, and, accordingly, it can be useful as the power source for the above mentioned motor driven devices.

Although a few embodiments of the present invention have been shown and described, it should be appreciated by those skilled in the art that changes may be made to the disclosed embodiments without departing from the principles and spirit of the invention, the scope of which is defined in the claims and their equivalents.

1. A secondary battery comprising:
a container;
an electrode assembly including a positive plate, a negative plate, and a separator interposed between those two plates, the electrode assembly mounted inside the container;
a cap assembly fixed to the container to seal the container; and
a collector plate electrically connected to one of the positive or negative plates of the electrode assembly, the collector plate including a plate-shaped body and a contact portion projecting from the body to contact the corresponding positive or negative plate of the electrode assembly.

2. The secondary battery of claim 1, wherein the contact portion has at least one groove formed with a predetermined pattern on the body as the contact portion.

3. The secondary battery of claim 2, wherein a plurality of grooves are arranged in a radial shape on the collector plate.

4. The secondary battery of claim 3, wherein the plurality of grooves are arranged in a cross shape on the collector plate.

5. The secondary battery of claim 1, wherein the collector plate has at least one through hole for pouring an electrolyte.

6. The secondary battery of claim 1, wherein the contact portion is fixed to the collector by a laser weld.

7. The secondary battery of claim 1, wherein the body has an integrally formed tab, the tab being electrically connected to the cap assembly.

8. The secondary battery of claim 7, wherein the tab is formed as an integral part of the body by cutting a portion of the body and bending the cut portion from the body.

9. The secondary battery of claim 1, wherein the secondary battery has a cylindrical shape.

10. The secondary battery of claim 1, wherein the secondary battery is used for a motor driven device.

11. The secondary battery of claim 1, wherein the collector plate is a positive collector plate with a first plate-shaped body and a first contact portion for contacting the positive plate, the secondary battery further comprising a negative collector plate having a second plate-shaped body and a second contact portion projecting from the second body to contact the negative plate of the electrode assembly.

12. The secondary battery of claim 11 wherein each of the positive and negative collector plates has at least one groove formed with a predetermined pattern as the corresponding contact portion.

13. A secondary battery comprising:
a container;
an electrode assembly including a positive plate, a negative plate, and a separator interposed between those two plates, the electrode assembly mounted inside the container;
a cap assembly fixed to the container to seal the container; and
a collector plate electrically connected to one of the positive or negative plates of the electrode assembly, the collector plate including a body defining at least one groove as a contact portion projecting from the body to contact the corresponding positive or negative plate of the electrode assembly; and a tab for electrically connecting the collector plate to the cap assembly.

14. The secondary battery of claim 13, wherein the body defines a plurality of grooves.

15. The secondary battery of claim 14, wherein the plurality of grooves are arranged radially on the body.

16. The secondary battery of claim 14, wherein the tab is integral to the body.

17. The secondary battery of claim 13, wherein the contact portion is fixed to the collector by a laser weld.
